(19) United States
(12) Patent Application Publication
(10) Pub. No.: US 2021/0275992 A1
(43) Pub. Date: Sep. 9, 2021

(54) METHOD OF MANUFACTURING COMPOSITE CATALYST

(71) Applicant: National Taiwan University of Science and Technology, Taipei (TW)

(72) Inventors: Bing-Joe Hwang, Taipei (TW); Wei-Nien Su, Taipei (TW); Chen-Yu Tsai, New Taipei City (TW); Hsiao-Chun Huang, Taoyuan City (TW); Meng-Che Tsai, Kaohsiung City (TW); Chun-Jern Pan, Taipei (TW)

(73) Assignee: National Taiwan University of Science and Technology, Taipei (TW)

(21) Appl. No.: 16/996,919

(22) Filed: Aug. 19, 2020

(30) Foreign Application Priority Data
Mar. 6, 2020 (TW) 109107367

(51) Int. Cl. B01J 23/42; B01J 21/06; B01J 21/18; B01J 35/00; B01J 37/02; B01J 37/08

(52) U.S. Cl. CPC B01J 23/42; B01J 21/063; B01J 21/18; B01J 35/0033; B01J 37/0219; B01J 37/0236; B01J 37/084; B01J 35/0013

(57) ABSTRACT

A method of manufacturing a composite catalyst is provided. The method includes the following steps. A catalyst composition including an inorganic support and a metallic nanoparticle attached to a surface of the inorganic support is provided. The catalyst composition, an organic material, and an acidic solvent are mixed to obtain a first mixed solution. An oxidant and the first mixed solution are mixed to obtain a second mixed solution. A drying process is performed on the second mixed solution to remove a solvent in the second mixed solution and to obtain a solid composite catalyst precursor. A calcination process is performed on the composite catalyst precursor to form a carbon-decorated composite catalyst.

### CROSS-REFERENCE TO RELATED APPLICATION

This application claims the priority benefit of Taiwan application serial no. 109107367, filed on Mar. 6, 2020. The entirety of the above-mentioned patent application is hereby incorporated by reference herein and made a part of this specification.

### BACKGROUND OF THE INVENTION

### Field of the Invention

The invention relates to a method of manufacturing a catalyst, and in particular, to a method of manufacturing a composite catalyst.

### Description of Related Art

Generally, a catalyst support may include a carbon support (such as carbon black or carbon nanotube) or a non-carbon support (such as an oxide material). The disadvantage of using a carbon support as a catalyst support is that the issue of carbon corrosion is more likely to occur. Corrosion of the carbon support causes an active unit (such as a precious metal nanoparticle) attached to the surface of the carbon support to fall off, thereby causing the loss of the active unit. Corrosion of the carbon support also causes aggregation of the precious metal nanoparticles, thus reducing reaction area.

Although the use of a non-carbon support as a catalyst support may avoid the issue of carbon corrosion, the non-carbon support has worse electrical conductivity. The non-carbon support may be improved in crystallinity or produce a specific crystal phase after high-temperature calcination to improve the electrical conductivity of the catalyst support. However, after the catalyst material is subjected to high-temperature treatment, the surface area of the active unit and the catalyst support is greatly reduced, thus adversely affecting the application of the catalyst.

### SUMMARY OF THE INVENTION

The invention provides a method of manufacturing a composite catalyst that may manufacture a catalyst having high electrical conductivity.

A method of manufacturing a composite catalyst of the invention includes the following steps. First, a catalyst composition is provided, wherein the catalyst composition includes an inorganic support and a metallic nanoparticle attached to a surface of the inorganic support. Next, the catalyst composition, an organic material, and an acidic solvent are mixed to obtain a first mixed solution. Then, an oxidant and the first mixed solution are mixed to obtain a second mixed solution. Then, a drying process is performed on the second mixed solution to remove the solvent in the second mixed solution and to obtain a solid composite catalyst precursor. Then, a calcination process is performed on the composite catalyst precursor to form a carbon-decorated composite catalyst.

In an embodiment of the invention, the inorganic support is, for example, a titanium dioxide, a ruthenium dioxide, an iridium dioxide, or a zinc oxide.

In an embodiment of the invention, the metallic nanoparticle is, for example, platinum, gold, or silver.

In an embodiment of the invention, based on a total weight of the catalyst composition, a content of the inorganic support is, for example, 60 wt % to 99.5 wt %, and a content of the metallic nanoparticle is, for example, 0.5 wt % to 40 wt %.

In an embodiment of the invention, the organic material is, for example, an aniline monomer, asphalt, acrylonitrile, or a derivative of acrylonitrile.

In an embodiment of the invention, a molar ratio of the oxidant to the aniline monomer is 10:1 to 1:10.

In an embodiment of the invention, the oxidant and the first mixed solution may be mixed at −5° C. to 10° C.

In an embodiment of the invention, before the oxidant and the first mixed solution are mixed, the oxidant may be dissolved in the acidic solvent.

In an embodiment of the invention, a calcination temperature of the calcination process is 350° C. or higher and a calcination time of the calcination process is 4 hours or more.

In an embodiment of the invention, the inorganic support is a titanium dioxide support, the composite catalyst includes a Magneli-phase titanium oxide, and the Magneli-phase titanium oxide is located on a surface of the titanium dioxide support.

Based on the above, in the method of manufacturing the composite catalyst of the invention, the catalyst composition is covered by forming an organic material as a carbon source, and then the catalyst composition is subjected to a calcination process under the cover of the organic material to form a carbon-decorated composite catalyst. In this way, the issue of reduced surface area of the metallic nanoparticle and the support due to high-temperature calcination during the general manufacturing process of a catalyst may be avoided. In addition, the carbon material covering the surface of the support also helps to enhance the electrical conductivity of the support. Furthermore, the composite catalyst manufactured by the invention has the characteristics of high active area, high dispersion area, high electrical conductivity, enhanced active unit-support electron interaction, high reactivity, and excellent durability.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a manufacturing flowchart of a composite catalyst according to an embodiment of the invention.

FIG. 2 is a scanning electron microscope image of the catalyst of Comparative example 1.

FIG. 3 is a scanning electron microscope image of the catalyst of Example 6.

FIG. 4 is a Raman spectrum of the composite catalysts of Example 4 to Example 6.

### DESCRIPTION OF THE EMBODIMENTS

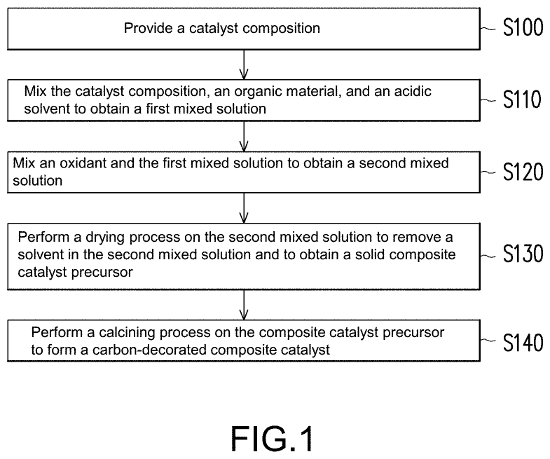

FIG. 1 is a manufacturing flowchart of a composite catalyst according to an embodiment of the invention.

Please refer to FIG. 1. The detailed description of the steps for manufacturing the composite catalyst is as follows.

First, step S100 is performed. A catalyst composition is provided. The catalyst composition includes an inorganic support and a metallic nanoparticle attached to a surface of the inorganic support. The inorganic support is, for example, a titanium dioxide, a ruthenium dioxide, an iridium dioxide, or a zinc oxide, but the invention is not limited thereto. The metallic nanoparticle may be used as an active unit of the composite catalyst of the invention. The metallic nanoparticle is, for example, platinum, gold, or silver, but the invention is not limited thereto. In an embodiment, based on a total weight of the catalyst composition, a content of the inorganic support is, for example, 60 wt % to 99.5 wt %, and a content of the metallic nanoparticle is, for example, 0.5 wt % to 40 wt %.

In an embodiment, Pt/TiO₂ is used as the catalyst composition of the invention. The method of manufacturing the catalyst composition Pt/TiO₂ is, for example, a microwave-assisted ethylene glycol reduction method. In an embodiment, the catalyst composition Pt/TiO₂ is manufactured, for example, by the following steps. First, 0.1 g of a titanium dioxide support and 20 ml of ethylene glycol are placed into a 100 ml round bottom flask and stirred uniformly for 5 minutes, and then oscillated by ultrasound for 30 minutes. Then, 0.0664 g of H₂PtCl₆.6H₂O and 2 ml of ethylene glycol are placed into a 20 ml sample bottle and oscillated by ultrasound for 5 minutes. The two sample solutions are mixed uniformly, stirred for 5 minutes, and then oscillated by ultrasound for 20 minutes. Then, the pH is adjusted to 11 with 1M NaOH, and then placed in a microwave reactor for microwave reaction for ten minutes (200 W, 160° C.). Next, a catalyst powder is collected by centrifugation, washed with water, and dried under vacuum at 60° C. to obtain a catalyst composition.

Then, step S100 is performed. The catalyst composition, an organic material, and an acidic solvent are mixed to obtain a first mixed solution. The organic material is, for example, an aniline monomer, asphalt, polyethylene glycol, polyethylene oxide, acrylonitrile, or a derivative of acrylonitrile. In the present embodiment, the derivative of acrylonitrile is, for example, vulcanized polyacrylonitrile. In an embodiment, the organic material is, for example, hexamethyldisilazane (HMDS) or tetraethyl orthosilicate (TEOS). In the present embodiment, the aniline monomer is, for example, a distilled aniline monomer. The acidic solvent is, for example, hydrochloric acid, nitric acid, or sulfuric acid. In an embodiment, for example, hydrochloric acid having a concentration of 0.1 M to 5 M is used as the acidic solvent. In an embodiment, the weight ratio of the catalyst composition, the aniline monomer, and the acidic solvent is, for example, 3:1:180. However, the invention is not limited thereto, and the types of the organic material and the acidic solvent and the ratio of the organic material to the acidic solvent may be adjusted as needed.

The method of mixing the catalyst composition, the organic material, and the acidic solvent includes, for example, uniformly dissolving the catalyst composition and the organic material in an acidic solution using ultrasound oscillation. During the mixing process, the organic material is acidified by the acidic solvent. The acidified organic material and the acidic environment facilitate the subsequent organic material to cover the catalyst composition.

In the present embodiment, before the catalyst composition, the organic material, and the acidic solvent are mixed (that is, before step S110 is performed), the catalyst composition may be subjected to a pure hydrogen treatment to ensure that the surface of the metallic nanoparticle is in a reduced state, and the metallic nanoparticle and impurities on the surface of the inorganic support are removed. In the present embodiment, the method of performing the pure hydrogen treatment includes, for example, heating the catalyst composition in an atmosphere of H₂ and at 150° C. to 400° C.

Then, step S120 is performed. An oxidant and the first mixed solution are mixed to obtain a second mixed solution. During the process of mixing the oxidant and the first mixed solution, the oxidant initiates a polymerization reaction of the organic material and covers the catalyst composition. The oxidant is, for example, ammonium persulfate, potassium persulfate, hydrogen peroxide, or sodium perbromide, but the invention is not limited thereto. The molar ratio of the oxidant to the organic material is 10:1 to 1:10. When the molar ratio of the oxidant to the organic material is within the above range, the degree of polymerization of the organic material is better. In the present embodiment, the oxidant and the first mixed solution may be mixed at −5° C. to 10° C. The low temperature environment is conducive to improving the degree of polymerization of the organic material.

In the present embodiment, the oxidant and the first mixed solution are directly mixed to obtain a second mixed solution. In another embodiment, before the oxidant and the first mixed solution are mixed, the oxidant may be subjected to an acidification treatment to acidify the oxidant. Specifically, the oxidant may be dissolved in an acidic solvent to obtain an oxidant solution. In the present embodiment, the acidic solvent is the same as the acidic solvent used to perform the acidification treatment on the organic material. The acidified oxidant and the acidic environment facilitate the polymerization reaction of the organic material. Then, the oxidant solution and the first mixed solution are directly mixed to obtain the second mixed solution.

Then, step S130 is performed. A drying process is performed on the second mixed solution to remove a solvent in the second mixed solution and to obtain a solid composite catalyst precursor. In detail, in the present embodiment, the method of performing the drying process on the second mixed solution includes, for example, the following steps. First, the solvent in the second mixed solution is removed using a reduced-pressure concentrator to obtain a flaky solid. Next, the flaky solid is washed with a mixed solution of distilled water and alcohol (volume ratio 1:1) to neutralize the flaky solid. Then, the flaky solid is vacuum-dried to obtain a solid composite catalyst precursor.

Then, step S140 is performed. A calcination process is performed on the composite catalyst precursor to form a carbon-decorated composite catalyst. In an embodiment, the calcination temperature of the calcination process is, for example, 350° C. or higher. In another embodiment, the calcination temperature of the calcination process is, for example, 350° C. to 1000° C. In an embodiment, the calcination time of the calcination process is, for example, 4 hours or more. In another embodiment, the calcination time is, for example, 4 hours to 6 hours. The atmosphere of the calcination process is, for example, argon. During the calcination process, the organic material may be used as a carbon source to form a carbon material on the surface of the inorganic support. The carbon material covering the surface of the inorganic support helps to enhance the electrical conductivity of the support.

In the present embodiment, the calcination process may include a plurality of calcination stages, wherein each of the calcination stages has a different calcination temperature. In detail, a second calcination stage may be performed after the first calcination stage, and then a third calcination stage may be performed, wherein the calcination temperature of the second calcination stage is higher than the calcination temperature of the first calcination stage, and the calcination temperature of the third calcination stage is higher than the calcination temperature of the second calcination stage. The number of calcination stages and the calcination temperature and the calcination time of the calcination stages may be determined as needed.

In addition, in the present embodiment, since the catalyst composition is calcined under the cover of the organic material, the organic material used as a shell may disperse the metallic nanoparticle and prevent the metallic nanoparticle from agglomerating due to high-temperature heating, thereby avoiding reduction in surface area of the active unit of the catalyst. In addition, cracking and carbonization phenomena may occur to the organic material under high temperature effects, thus helping to enhance the electrical conductivity of the support.

In the present embodiment, a TiO₂ support is used as the inorganic support. By performing the calcination process in the above situation, the organic material may also be used as a reducing agent to reduce the surface of the TiO₂ support to form a Magneli-phase titanium oxide on the surface of the TiO₂ support. Specifically, the structure of TiO₂ is changed from the Anatase-phase to the-Rutile phase, and lastly the Magneli-phase with excellent electrical conductivity is formed. The general formula of the Magneli-phase titanium oxide is TiₙO₂ₙ₋₁, wherein n is an integer of 3 to 10. Specifically, the Magneli-phase titanium oxide is, for example, one or more of Ti₃O₅, Ti₄O₇, Ti₅O₉, Ti₆O₁₁, Ti₇O₁₃, Ti₈O₁₅, Ti₉O₁₇, and Ti₁₀O₁₉. The Magneli-phase titanium oxide has excellent electrical conductivity, and at the same time has high surface area, thus increasing the electrical conductivity of the inorganic support and improving the catalytic activity of the catalyst.

In the present embodiment, an acid cleaning process may be further performed on the carbon-decorated composite catalyst to remove an excessively thick carbon material on the surface of the composite catalyst. The acidic solution for performing the acid cleaning process is, for example, hydrofluoric acid.

The composite catalyst manufactured using the manufacturing method of the present embodiment has the characteristics of high active area, high dispersion area, high electrical conductivity, enhanced active unit-support electron interaction, high reactivity, and excellent durability, and is therefore suitable for application in super capacitor materials.

In addition, when a TiO₂ support is used as the inorganic support of the invention, the organic material may also be used as a reducing agent to reduce the surface of the TiO₂ support so as to form a Magneli-phase titanium oxide to help to improve the electrical conductivity of the support.

Next, the characteristics of the composite catalyst manufactured by the method of preparing the composite catalyst of the invention are described with examples. However, without departing from the spirit of the invention, the materials and usage methods . . . etc. in the following examples may be suitably modified. Therefore, the scope of the invention should not be construed to the following examples.

### Example 1

First, 0.1 g of a Pt/TiO₂ catalyst composition was placed into an L-shaped tube, 99.99% H₂ was introduced at a rate of 40 ml/min, and heating was performed to 200° C. at a rate of 10° C./min to heat the Pt/TiO₂ catalyst composition for 1 hour. Next, 0.1 g of the Pt/TiO₂ catalyst composition treated with pure hydrogen and 0.033 ml of a distilled aniline monomer were added to 50 ml of 1M hydrochloric acid and uniformly mixed for 1 hour using ultrasonic oscillation. Next, the mixed solution and an ammonium persulfate solution (0.0817 g of ammonium persulfate dissolved in 50 ml of 1M hydrochloric acid) were mixed, and the mixture was uniformly stirred at 5° C. and a rotation speed of 700 rpm for 20 hours. Next, the solution was drained using a reduced-pressure concentrator to obtain a flaky solid. The flaky solid was washed with a mixed solution of distilled water and alcohol (volume ratio 1:1) to neutralize the flaky solid. The flaky solid was vacuum dried at 80° C. for 8 hours to obtain a composite catalyst precursor. Then, the dried composite catalyst precursor was placed into an L-shaped tube, pure argon gas was introduced at a rate of 40 cc/min, and heating was performed to 350° C. at a rate of 5° C./min and a constant temperature was kept for 4 hours to obtain a carbon-decorated composite catalyst. Next, the obtained product was placed in 2% hydrofluoric acid for 6 hours, centrifuged, and a powder was collected. The collected powder was rinsed to neutral with distilled water. The cleaned powder was placed in a vacuum oven and dried at 80° C. for 8 hours.

### Example 2

A method similar to that of Example 1 was used to manufacture a composite catalyst, and the difference was that the calcination temperature of Example 2 was 550° C.

### Example 3

A method similar to that of Example 1 was used to manufacture a composite catalyst, and the difference was that the calcination temperature of Example 3 was 750° C.

### Example 4

A method similar to that of Example 1 was used to manufacture a composite catalyst, and the difference was that the calcination temperature of Example 4 was 850° C.

### Example 5

A method similar to that of Example 1 was used to manufacture a composite catalyst, and the difference was that the calcination temperature of Example 5 was 900° C.

### Example 6

A method similar to that of Example 1 was used to manufacture a composite catalyst, and the difference was that the calcination temperature of Example 5 was 950° C.

### Comparative Example 1

In the present embodiment, 20 wt % of a platinum nanoparticle was supported on a (standard) titanium dioxide support, and a Pt/TiO₂ catalyst not modified with polyaniline was used as the catalyst of Comparative example 1.

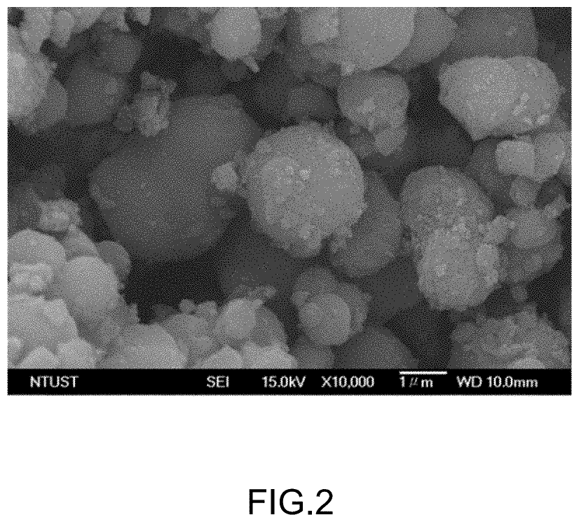

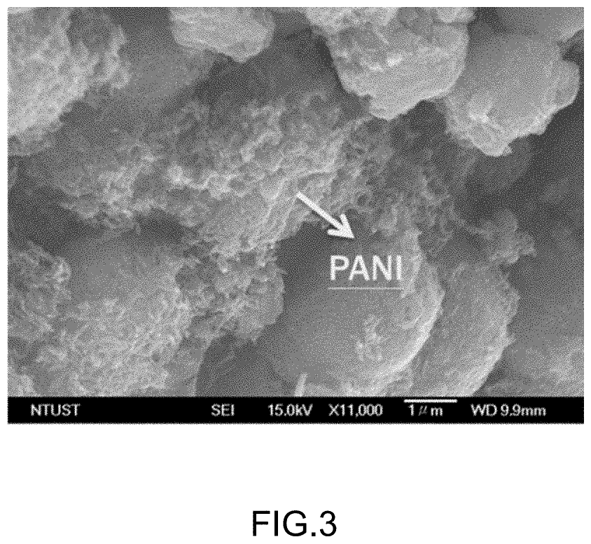

FIG. 2 is a scanning electron microscope image of the catalyst of Comparative example 1. FIG. 3 is a scanning electron microscope image of the catalyst of Example 6.

It may be seen from FIG. 2 and FIG. 3 that the polyaniline used as a carbon source covers the Pt/TiO₂ catalyst, and therefore helps to enhance the electrical conductivity of the support.

In the present embodiment, in order to confirm whether the Magneli-phase titanium oxide is formed on the surface of the TiO₂ support of the composite catalyst of the invention, Raman spectroscopy analysis was performed on the composite catalysts of Example 4 to Example 6 using infrared light at 10% intensity.

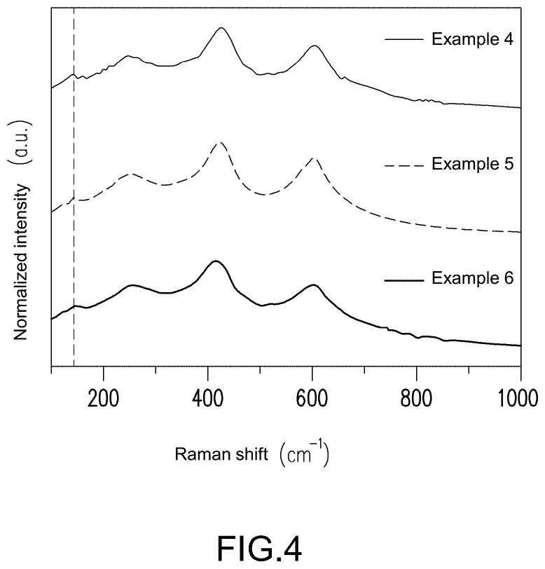

FIG. 4 is a Raman spectrum of the composite catalysts of Example 4 to Example 6, wherein the characteristic peak of Ti₄O₇ is located at 140 cm⁻¹, and the characteristic peaks of the Rutile-phase are located at 255 cm⁻¹, 418 cm⁻¹, and 603 cm⁻¹. It may be seen from FIG. 4 that when the composite catalysts of Example 4 to Example 6 are irradiated with infrared light at 10% intensity, the peak at 140 cm⁻¹ is higher, and therefore it may be inferred that Ti₄O₇ (Magneli-phase titanium oxide) is formed on the surface of the TiO₂ support. The Magneli-phase titanium oxide has excellent electrical conductivity, and at the same time has high surface area, thus increasing the electrical conductivity of the inorganic support and improving the catalytic activity of the catalyst.

Based on the above, in the method of manufacturing the composite catalyst of the invention, the catalyst composition is covered by forming an organic material as a carbon source, and then the catalyst composition is subjected to a calcination process under the cover of the organic material to form a carbon-decorated composite catalyst. In this way, the issue of reduced surface area of the metallic nanoparticle and the support due to high-temperature calcination during the general manufacturing process of a catalyst may be avoided. In addition, the carbon material covering the surface of the support also helps to enhance the electrical conductivity of the support. Furthermore, the composite catalyst manufactured by the invention has the characteristics of high active area, high dispersion area, high electrical conductivity, enhanced active unit-support electron interaction, high reactivity, and excellent durability.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A method of manufacturing a composite catalyst, comprising:
providing a catalyst composition, wherein the catalyst composition comprises an inorganic support and a metallic nanoparticle attached to a surface of the inorganic support;
mixing the catalyst composition, an organic material, and an acidic solvent to obtain a first mixed solution;
mixing an oxidant and the first mixed solution to obtain a second mixed solution;
performing a drying process on the second mixed solution to remove the solvent in the second mixed solution and to obtain a solid composite catalyst precursor; and
performing a calcination process on the composite catalyst precursor to form a carbon-decorated composite catalyst.

2. The method of manufacturing the composite catalyst of claim 1, wherein the inorganic support comprises a titanium dioxide, a ruthenium dioxide, an iridium dioxide, or a zinc oxide.

3. The method of manufacturing the composite catalyst of claim 1, wherein the metallic nanoparticle comprises platinum, gold, or silver.

4. The method of manufacturing the composite catalyst of claim 1, wherein based on a total weight of the catalyst composition, a content of the inorganic support is 60 wt % to 99.5 wt %, and a content of the metallic nanoparticle is 0.5 wt % to 40 wt %.

5. The method of manufacturing the composite catalyst of claim 1, wherein the organic material comprises an aniline monomer, asphalt, acrylonitrile, or a derivative of acrylonitrile.

6. The method of manufacturing the composite catalyst of claim 1, wherein a molar ratio of the oxidant to the organic material is 10:1 to 1:10.

7. The method of manufacturing the composite catalyst of claim 1, wherein the oxidant and the first mixed solution are mixed at −5° C. to 10° C.

8. The method of manufacturing the composite catalyst of claim 1, further comprising, before the oxidant and the first mixed solution are mixed, dissolving the oxidant in the acidic solvent.

9. The method of manufacturing the composite catalyst of claim 1, wherein a calcination temperature of the calcination process is 350° C. or higher and a calcination time of the calcination process is 4 hours or more.

10. The method of manufacturing the composite catalyst of claim 2, wherein the inorganic support is a titanium dioxide support, the composite catalyst comprises a Magneli-phase titanium oxide, and the Magneli-phase titanium oxide is located on a surface of the titanium dioxide support.
